(19) United States
(12) Patent Application Publication
(10) Pub. No.: US 2012/0313901 A1
(43) Pub. Date: Dec. 13, 2012

(54) COMPENSATING FOR AN ANTENNA THAT IS CLOSE ENOUGH TO A TOUCHPAD TO CAUSE INTERFERENCE WITH TOUCH SENSOR OPERATION

(75) Inventor: Brian Monson, Farmington, UT (US)

(73) Assignee: CIRQUE CORPORATION, Salt Lake City, UT (US)

(21) Appl. No.: 13/458,639

(22) Filed: Apr. 27, 2012

Related U.S. Application Data
(60) Provisional application No. 61/494,585, filed on Jun. 8, 2011.

(51) Int. Cl. G06F 3/041

(52) U.S. Cl. 345/178

(57) ABSTRACT

A touch sensor that can operate normally while located within a distance that would otherwise cause an antenna used for communication with a contact less smart card to interfere with operation of the touch sensor by providing a means for the touch sensor to compensate for the interference caused by the antenna.

### CROSS REFERENCE TO RELATED APPLICATIONS

This document claims priority to and incorporates by reference all of the subject matter included in the provisional patent application docket number 4981.CIRQ.PR, having Ser. No. 61/494,585, filed. Jun. 8, 2011.

### BACKGROUND OF THE INVENTION

1. Field of the Invention

This invention relates generally to touch sensor technology used in conjunction with an antenna. More specifically, the present invention enables an antenna that is used to provide communication with devices that use wireless technology, such as a smart card, to operate close enough to a touch sensor (such as a touchpad or touchscreen) that the antenna would normally cause interference with normal touch sensor operation.

2. Description of Related Art

The state of the art of smart cards has changed as the concept of smart cards has evolved. A typical smart card is a device having a housing that is often the same size as a credit card. The housing typically includes some sort of memory that enables the smart card to store information. Thus, the smart card is “smart” enough to store data and/or applications. Some smart cards also include some rudimentary data processing capabilities through the addition of a processor. The result, is that it is possible for the smart card to carry with it information in order to facilitate financial transactions.

Smart cards now in use can store personal information, hold digital cash and/or prove identity. Smart cards are often contrasted with “dumb” cards that have magnetic strips or barcodes that rely more heavily on networks in order to function.

Despite the lack of penetration of smart cards into the U.S. mark, it appears that a modified smart. card may become more popular in the United States. This evolved smart card is known as a “contactless card” or “contactless smart card”. contactless smart card is identical in size and appearance to a typical smart card, but it incorporates a new interface for communication with card reader. This new smart card uses radio frequency transmission capabilities to communicate with compatible contactless smart card reader terminals.

The traditional smart card and dumb card must. be inserted into or swiped through a card reader, whereas the contactless smart card only has to be brought close enough to the contactless smart card reader for wireless radio communication between the card. reader and the contactless smart card to take place.

For example, a contact less smart card often used in walk-by or gate access applications for mass transit, or as a security identification card that can open a door or provide other access to a secure location. Contactless smart cards are even being used as verification of identity during some financial transactions that are performed electronically. For example, the contactless smart card is used to verify the identity of the party requesting the transaction.

The contactless smart card typically hides a microchip within a plastic housing and communicates through radio waves. Power for operation of a radio transceiver is provided to the contactless smart card through inductance coils and communication occurs via radio frequency signals and a capacitive plate antenna.

As contactless smart cards achieve greater penetration into the marketplace, the need is arising for contactless smart card terminals to be widely available for users. For example, in the case of using the contact less smart card to verify identity, it would be an advantage if a contactless smart card reader was available in devices that are also ubiquitous, such as in electronic devices that are commonly found at point-of-sale (POS) locations.

One of the problems with providing an antenna for use with a contactless card reader that is near a touchpad or touchscreen is that the antenna can interfere with normal touch sensor operation. Accordingly, it would be an advantage over the prior art to provide a means for eliminating interference caused by the antenna and provide normal touch sensor operation regardless of the distance between he touch sensor and the antenna.

Touchpad and touchscreen technology that can operate with the antenna is offered by CIRQUE® Corporation. In this technology of CIRQUE® Corporation, a grid of row and column electrodes is used to define the touch-sensitive area of the touchpad. Typically, the touchpad is a rectangular grid. of approximately 16 by 12 electrodes, or 8 by 6 electrodes when there are space constraints. Interlaced with these row and column electrodes is a single sense electrode. All position. measurements are made through the sense electrode. However, the row and column electrodes can also act as the sense electrode, so the important aspect is that at least one electrode is driving a signal, and another electrode is used for detection of a signal.

In more detail, FIG. 1 shows a capacitance sensitive touchpad 10 as taught by CIRQUE® Corporation includes a grid of row (12) and column (14) (or X and Y) electrodes in a touchpad electrode grid. All measurements of touchpad. parameters are taken from a single sense electrode 16 also disposed on the touchpad electrode grid, and not from the X or Y electrodes 12, 14. No fixed reference point is used for measurements. Touchpad sensor control circuitry 20 generates signals from P,N generators 22, 24 that are sent directly to the X and Y electrodes 12, 14 in various patterns. Accordingly, there is a one-to-one correspondence between the number of electrodes on the touchpad electrode grid, and the number of drive pins on the touchpad sensor control circuitry 20.

The touchpad 10 does not depend upon an absolute capacitive measurement to determine the location of a finger (or other capacitive object) on the touchpad surface. The touchpad 10 measures an imbalance in electrical charge to the sense line 16. When no pointing object is on the touchpad 10, the touchpad sensor control circuitry 20 is in a balanced state, and there is no signal on the sense line 16. There may or may not be a capacitive charge on the electrodes 12, 14. In the methodology of CIRQUE® Corporation, that is irrelevant. When a pointing device creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14. The touchpad 10 determines the change in capacitance by measuring the amount of charge that must be injected onto the sense line 16 to reestablish or regain balance on the sense line.

The touchpad 10 must make two complete measurement cycles for the X electrodes 12 and for the Y electrodes 14 (four complete measurements) in order to determine the position of a pointing object such as a finger. The steps are as follows for both the X 12 and the Y 14 electrodes:

First, a group of electrodes (say a select group of the X electrodes 12) are driven with a first signal from P, N generator 22 and a first measurement. using mutual capacitance measurement device 26 is taken to determine the location of the largest signal. However, it is not possible from this one measurement to know whether the finger is on one side or the other of the closest electrode to the largest signal.

Next, shifting by one electrode to one side of the closest electrode, the group of electrodes is again driven with a signal. In other words, the electrode immediately to the one side of the group is added, while the electrode on the opposite side of the original group is no longer driven.

Third, the new group of electrodes is driven and a second measurement is taken.

Finally, using an equation that compares the magnitude of the two signals measured, the location of the finger is determined.

Accordingly, the touchpad 10 measures a change in capacitance in order to determine the location of a finger. All of this hardware and the methodology described above assume that the touchpad sensor control circuitry 20 is directly driving the electrodes 12, 14 of the touchpad 10. Thus, for a typical 12×16 electrode grid touchpad, there are a total of 28 pins (12+16=28) available from the touchpad sensor control circuitry 20 that are used to drive the electrodes 12, 14 of the electrode grid.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the CIRQUE® touchpad described above uses a grid of X and Y electrodes and a separate and single sense electrode, the sense electrode can also be the X or Y electrodes by using multiplexjnq. Either design will enable the present invention to function.

The underlying technology for the CIRQUE® Corporation touchpad is based on capacitive sensors. As was mentioned, other touchpad technologies can also be used for the present invention. These other proximity-sensitive and touch-sensitive touchpad technologies include but should not be considered limited to electromagnetic, inductive, pressure sensing, electrostatic, ultrasonic, optical, resistive membrane, semi-conductive membrane or other finger or stylus-responsive technology.

### BRIEF SUMMARY OF THE INVENTION

It is an object of the present invention to provide a touch sensor that can operate normally while located within a distance that would otherwise cause an antenna used for communication with a contactless smart card to interfere with operation of the touch sensor by providing a means for the touch sensor to compensate for the interference caused by the antenna.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which. can be operated in accordance with the principles of the present invention.

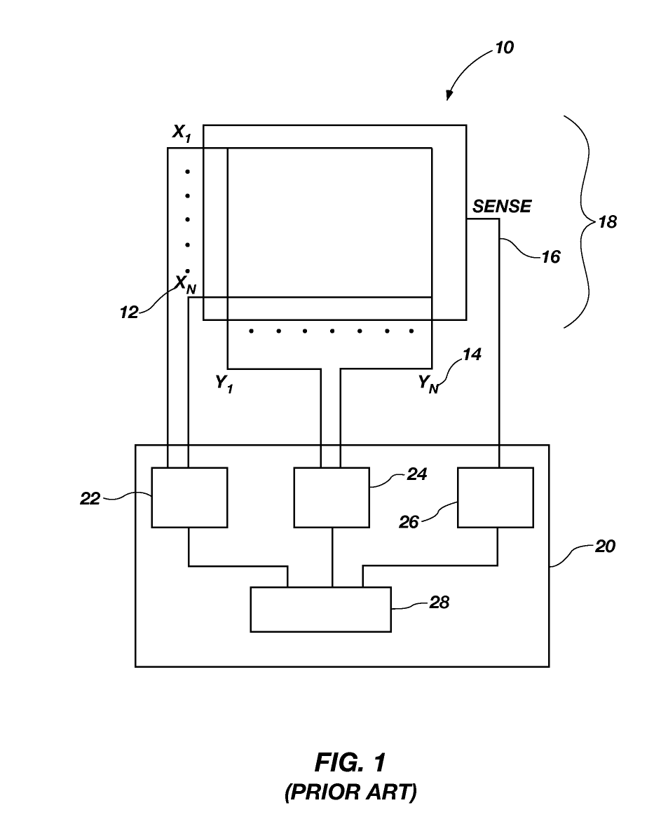

FIG. 2 is a perspective view of a point-of-sale (POS) device including a touch screen that operates using the principles of the CIRQUE® Corporation touchpad technology.

FIG. 3 is a top view of a touchscreen circuit board with the contactless smart card reader antenna disposed thereon.

FIG. 4 is a block diagram. of the functionality provided by the electronic circuitry within the POS device.

### DETAILED DESCRIPTION OF THE INVENTION

Reference will now be made to the drawings in which the various elements of the present invention will be given numerical designations and in which the invention will be discussed so as to enable one skilled in the art to make and use the invention. it is to be understood that the following description is only exemplary of the principles of the present invention, and should not be viewed as narrowing the claims which follow.

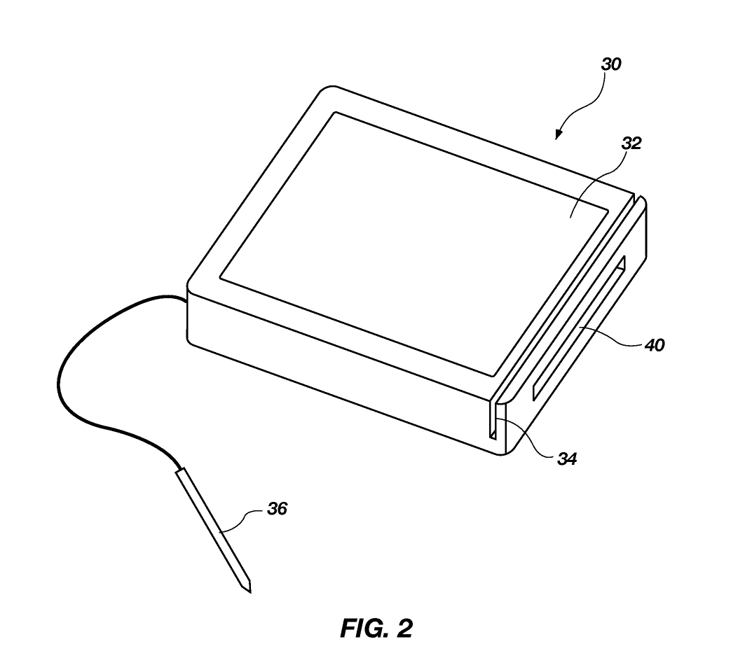

FIG. 2 shows that the presently preferred embodiment of the invention is a touchpad or a touchscreen 32 (hereinafter a “touch sensor”) disposed in a POS input device 30. For example, when a user provides a credit card or a debit card to a cashier for a purchase, it is common to see a dumb card reader 34 that enables the credit or debit card to be swiped through the reader in order to read the data stored on a magnetic strip. The user then typically uses a pen 36 that is coupled to the PCI input device 30 and either enters a signature or a debit card number. Thus, the CIRQUE® touch sensor technology is capable of receiving diverse forms of user input.

The POS device 30 also incorporates an antenna 40 that is close enough to interfere with normal touch sensor 32 operation. The exact position of the antenna 40 in relation to the touch sensor 32 is not critical to the invention. All that is important is that the antenna 40, wherever it is located on or within the POS input device 30, will likely interfere with touch sensor 32 operation. Thus, the antenna 40 can be in close proximity to the touch sensor 32, such as mounted to the side of the POS input device 30. Alternatively, the antenna 40 can be mounted inside the POS input, device 30 and underneath the touch sensor 32. Other physical arrangements of the position of the touch sensor 32 and the antenna 40 are also possible and should be considered to be within the scope of the present invention.

The touch sensor 32 is electrically coupled to touch sensor circuitry used to detect and track the movement of an object or objects on or near the touch. sensor surface. The touch sensor circuitry will be mounted on a circuit board within the POS device. It is even possible that the antenna is mounted on the touch sensor circuitry circuit board or substrate.

In this particular embodiment, a touch sensor contains a grid of vertical and horizontal electrodes which are connected to a sophisticated full-custom mixed signal integrated circuit (ASIC) and other touch sensor circuits mounted on the substrate. “Mutual capacitance” from each of the horizontal electrodes to each of the vertical electrodes is continually measured by the touch sensor circuitry. A person's finger or other capacitive or dielectric object on or near the touch-sensitive surface of the touch. sensor alters the mutual capacitance between the vertical and horizontal electrodes. The position of the finger's center is precisely determined based. upon changes in mutual capacitance as the finger moves across the touch sensor.

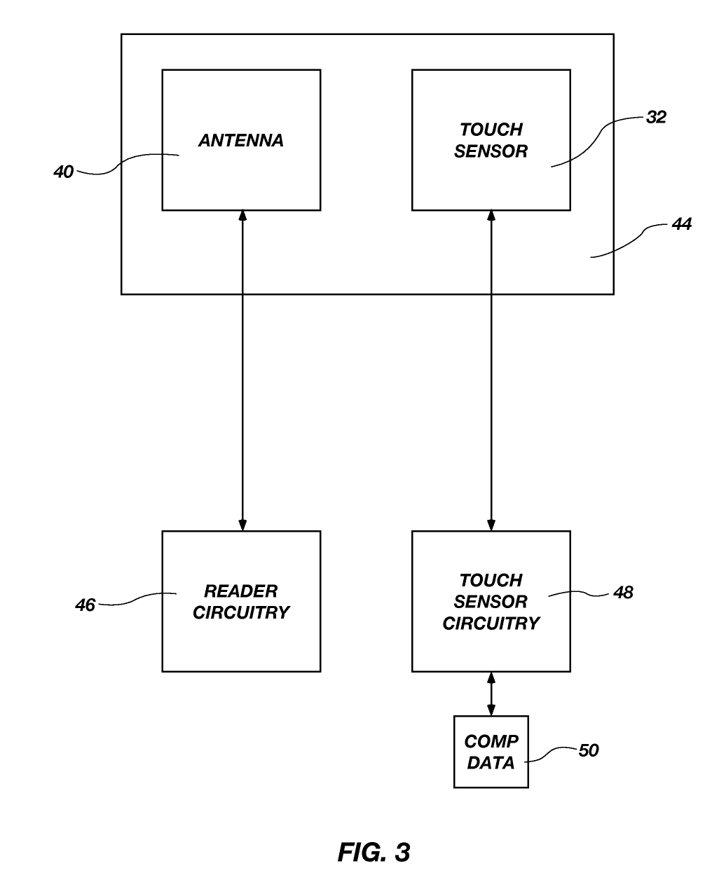

A contactless smart card reader system is comprised of an antenna. that broadcasts a signal to and receives a signal from a contactless smart card, contactless smart card reader circuitry (“reader circuitry” hereinafter), and a means for communicating with a network. FIG. 3 is provided as a block diagram that illustrates the concepts of the present invention and not a specific physical layout. The physical layout can vary greatly. All that is relevant is that the antenna 40 of the contactless smart card reader system be disposed near enough to the electrode grid of the touch sensor 32 that the antenna 40 can interfere with operation of the touch sensor. This means that the antenna 40 may be on the same substrate as the touch sensor 32 or it may not. It is noted that the substrate may be comprised. of PC board material, or it may be a flexible MYLAR®-type of substrate. The actual shape and composition of the antenna 40 can vary greatly. All that is required of the antenna 40 is that it provides a means of communication between a contactless smart card reader system and a contactless smart card. Thus, any antenna design. that mill perform. the desired function can be used.

FIG. 3 is directed to illustrating the concept that antenna 40 and the touch sensor are located within an operating volume 44 where the described interaction takes place. The touch sensor 32 and the antenna 40 of the contactless smart card reader also require a surface or substrate on which to mount circuitry. The touch sensor 32 requires touch sensor circuitry 48 for calculating the position of an object or objects in contact with the touch sensor 32. Most importantly, the touch sensor circuitry 48 includes the ability to compensate for the antenna 40. Likewise, the antenna 40 requires reader circuitry 46 that enables the contactless smart card reader system to perform its functions. The touch sensor circuitry 48 can be mounted on a substrate alone, or it can share a substrate with the reader circuitry 46.

The antenna 40 communicates with the reader circuitry 46, and the touch sensor 32 communicates with the touch sensor circuitry 48. The contactless smart card reader circuitry 46 is known to those skilled in the art, and can be assumed to be disposed either in the POS device but separate from the substrate of the touch sensor, or to be sharing the touch sensor substrate. The reader circuitry 46 includes all the circuitry necessary to send and receive radio frequency transmissions, to communicate with a contactless smart card, and to communicate with a network that will receive the data that is received through the antenna 40 from the contactless smart card.

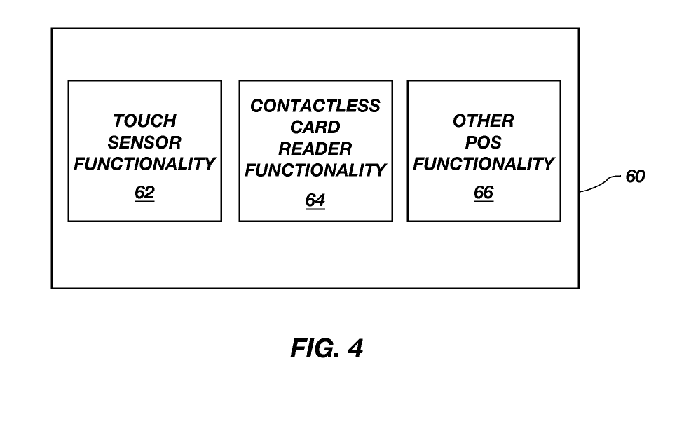

FIG. 4 is provided as a block diagram that illustrates the several functions that can be performed in a second embodiment of the present invention. This second embodiment is direct d to the functions that can be performed by a device that incorporates all of the functions shown in FIG. 3. In other words, consider a POS device as has been described above. The POS device 60 of the second embodiment includes touch sensor functionality 62 and contactless card reader functionality 64. Touchscreen functionality will likely include the touch sensor 32 and the touch sensor circuitry 48 of FIG. 3. The contactless card reader functionality will likely include the antenna 40 and the reader circuitry 46.

The POS device 60 may or may not include other POS functionality 66. The examples of functionality listed hereinafter are for illustration purposes only and should not be considered to be limiting. Accordingly, the POS device 60 may include such functions as biometric input such as for reading a fingerprint, a virtual keypad, a virtual keyboard, a physical keypad and a physical keyboard, and a magnetic stripe reader.

FIG. 4 should not be read as limiting the physical configurations of the functionality being provided, but only as representing the functionalities themselves.

Referring to FIG. 3, the operation of the present. invention is now as follows. The antenna has an inherent electrical potential when the antenna is not being driven with a signal (an “off” mode) , and a different electrical potential when it is being driven (an “on” mode). This difference in electrical potential in close proxmity to a touch sensor can substantially interfere with such sensor operation.

The interference can be as slight as preventing^{.} precise detection. and tracking of an object on or near the touch sensor, all the way to preventing operation of the touch sensor.

The touch sensor of the present invention. utilizes compensation or “comp” data 50 to make adjustments for the environment in which ;he touch. sensor is operating. These adjustments typically are made under the assumption that the environment of the touch sensor is essentially electrically static. However, the antenna in close proximity to the touch sensor results in a dynamically changing operating environment.

Accordingly, in a first. embodiment of the present invention, an additional compensation set of data is stared for use by the touch sensor. In a first set of compensation. data 50, the antenna is off. In second set of compensation data 50, the antenna is on. The touch sensor circuitry can perform a routine to determine if the antenna is being used, or it can be constructed so as to receive signal that indicates the operating status of the antenna, and use the appropriate compensation data 50 when the touch sensor is in operation.

In another alternative embodiment, the antenna circuitry sends a. signal to the touch. sensor circuitry indicating that a particular set of compensation data 50 should be used. For example, the touch sensor could always operate in a mode where it is assumed that the antenna is off. When the antenna is on, the antenna circuitry can send. a signal to the touch. sensor circuitry indicating a mode of operation. so that the correct compensation data 50 will be used that compensates for the antenna being on.

Alternatively, the touch sensor could always operate in a mode where it is assumed that the antenna is on. When the antenna is off, the antenna circuitry can send a signal to the touch sensor circuitry indicating a mode of operation that the compensation data 50 will be used that compensates for the antenna being off.

In an alternative embodiment, environmental factors may influence the operation of the touch sensor and the antenna to the point that the compensation data 50 is no longer accurate. These environmental factors include but should not be considered to be limited to temperature and humidity. Accordingly, it may be necessary to recalculate one or more compensation data sets in order to operate in a changing operating environment. The change in the operating environment must be a substantial, being defined as any change in the environment that is sufficient to cause the operation of the touch sensor 32 or the antenna 40 to be influenced by the operating environment.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for operating a touch sensor that is in proximity of an antenna that can interfere with operation of the touch sensor, said method comprising the steps of:
1) providing a touch sensor including an electrode grid disposed on a first substrate, and touch sensor circuitry for receiving signals from the electrode grid and detecting a pointing object that is touching a surface of the touch sensor;
2) providing an antenna for communicating with a contactless card reader;
3) disposing the antenna in a location that when used may cause interference with operation of the touch sensor;
4) providing a first set of compensation data that is used by the touch sensor circuitry when the antenna is on; and
5) accurately determining a location. of the pointing object on the surface of the touch sensor when the antenna is on by using the first set of compensation data.

2. The method as defined in claim. 1 wherein the method. further comprises the steps of:
1) providing a second set of compensation data that is used by the touch sensor circuitry when the antenna is off; and
2) accurately determining a location of the pointing object on a surface of the touch sensor when the antenna is off by using the second. set of compensation data.

3. The method as defined in claim 1. wherein the step of proving the antenna further comprises the step of providing a near field communication (NFC) antenna.

4. The method as defined in claim 1 wherein the step of providing the touch sensor further comprises the step of providing a capacitance sensitive touch sensor.

5. The method as defined in claim 1 wherein step of providing a touch sensor that can detect the pointing object in contact with the surface of the touch sensor further comprises the step of providing a touch sensor that can perform proximity detection of the pointing object when the pointing object is near the touch sensor.

6. The method as defined in claim 1 wherein the step of using a first set of compensation data when the antenna is on further comprises the step of the touch sensor circuitry receiving a signal from the antenna circuitry that indicates a mode of operation of the antenna so that the correct set of compensation data is used.

7. The method as defined in claim 2 wherein the step of providing a first set of compensation data that is used by the touch sensor circuitry when the antenna is on further comprises the step of dynamically updating the first or the second set of compensation data if the operating environment changes, to thereby enable the touch sensor and the antenna to continue to operate in a changing operating environment.

8. The method as defined in claim 7 wherein the step of dynamically updating the first or the second set of compensation data if the operating environment changes further comprises the step of updating the first or the second set of compensation data when there is a substantial change in temperature or humidity sufficient to change operation of the touch sensor or the antenna.

9. A touch sensor system that operates accurately when in proximity of an antenna that can interfere with operation of the touch sensor, said system comprised of:
a touch sensor having a touch surface, and including an electrode grid disposed on a first substrate;
an antenna for communicating with a contactless card reader, wherein the antenna is disposed in a location that when used may cause interference with operation. of the touch sensor; and
touch sensor circuitry for receiving signals from the electrode grid and detecting a pointing object that is in contact with the touch surface, wherein the touch. sensor circuitry uses a first set of compensation data that compensates for the antenna when the antenna is on and accurately determines a location of the pointing cot.

10. The system as defined in claim 9 wherein the system further comprises a second set of compensation. data that is used by the touch sensor circuitry when the antenna is off to thereby accurately de ermine a location of the pointing object on the surface of the touch sensor.

11. The system as defined in claim 9 wherein. the antenna is a near field communication (NFC) antenna.

12. The system as defined in claim 9 wherein the touch sensor further is a capacitance sensitive touch sensor.

13. The system as defined in claim 9 wherein the touch sensor also performs proximity detection of the pointing object.
